(19) United States
(12) Patent Application Publication
(10) Pub. No.: US 2015/0303813 A1
(43) Pub. Date: Oct. 22, 2015

(54) AC-TO-DC POWER CONVERTING DEVICE

(71) Applicant: I SHOU UNIVERSITY, Kaohsiung City (TW)

(72) Inventors: Chun-An CHENG, Kaohsiung City (TW); Fu-Li YANG, Kaohsiung City (TW)

(73) Assignee: I SHOU UNIVERSITY, Kaohsiung City (TW)

(21) Appl. No.: 14/258,557

(22) Filed: Apr. 22, 2014

(51) Int. Cl. H02M 3/335; H02M 1/42

(52) U.S. Cl. CPC H02M 3/33546; H02M 1/42

(57) ABSTRACT

A power converting device includes a filter filtering an AC input voltage to generate a filtered voltage, a power factor corrector boosting the filtered voltage to generate a boosted voltage, and a step-down converter reducing the boosted voltage to generate a DC output voltage. The power factor corrector includes a capacitor, an inductor, two diodes and two switches. The inductor has a first terminal coupled to the filter, and a second terminal. The diodes are coupled in series across the capacitor. A common node between the diodes is coupled to the second terminal of the inductor. The switches are coupled in series across the capacitor. A voltage across one of the switches serves as the boosted voltage.

### BACKGROUND OF THE INVENTION

1. Field of the Invention

This invention relates to a power converting device, and more particularly to an AC-to-DC power converting device.

2. Description of the Related Art

Referring to FIG. 1, a conventional power converting device converts an alternating current (AC) input voltage (Vin) supplied by an AC power source 16 into a direct current (DC) output voltage (Vo) for driving a light emitting diode (LED) module 17 that serves as a load. The conventional power converting device includes a filter 10, a full-bridge rectifier 11, a power factor corrector 12, a step-down converter 13, and first and second controllers 14, 15.

The filter 10 is coupled to the AC power source 16 for receiving the AC input voltage (Vin) therefrom, and filters out high frequency noise from the AC input voltage (Vin) to generate a filtered voltage.

The full-bridge rectifier 11 is coupled to the filter 10 for receiving the filtered voltage therefrom, and rectifies the filtered voltage to generate a rectified voltage.

The power factor corrector 12 is a boost converter, and is coupled to the full-bridge rectifier 11 for receiving the rectified voltage therefrom. The power factor corrector 12 includes first to third capacitors (C1, C2, C3), first and second diodes (D1, D2), first and second inductors (L1, L2) and first and second switches (S1, S2). Each of the first and second switches (S1, S2) is operated alternately in an ON state and an OFF state based on a respective one of first and second control signals (Vgs1, Vgs2), so as to enable each of the first and second inductors (L1, L2) to alternately store and release energy. As a result, the rectified voltage is boosted to generate a boosted voltage.

The step-down converter 13 is coupled to the power factor corrector 12 for receiving the boosted voltage therefrom, and includes third and fourth switches (S3, S4) and other necessary components. Each of the third and fourth switches (S3, S4) is operated alternately in an ON state and an OFF state based on a respective one of third and fourth control signals (Vgs3, Vgs4), such that the boosted voltage is reduced to generate the DC output voltage (Vo).

The first controller 14 is coupled to the power factor corrector 12, and generates the first and second control signals (Vgs1, Vgs2).

The second controller 15 is coupled to the step-down converter 13, and generates the third and fourth control signals (Vgs3, Vgs4).

The conventional power converting device has the following drawbacks:

1. Since the power factor corrector 12 includes a relatively large number of components, and since the full-bridge rectifier 11 is required, the conventional power converting device has a relatively high cost.

2. Four switches (S1-S4) are required in the conventional power converting device.

3. Since four control signals (Vgs1-Vgs4) are required for controlling the four switches (S1-S4), respectively, control logic (including the first and second controllers 14, 15) of the conventional power converting device is relatively complicated.

4. Since the DC output voltage (Vo) is generated through a four-stage process (including the filteringby the filter 10, the rectification by the full-bridge rectifier 11, the boost by the power factor corrector 12 and the reduction by the step-down converter 13), since the four switches (S1-S4) are required, and since the control logic is relatively complicated, the conventional power converting device has relatively low power conversion efficiency.

### SUMMARY OF THE INVENTION

Therefore, an object of the present invention is to provide a power converting device that can overcome at least one of the aforesaid drawbacks associated with the prior art.

According to one aspect of this invention, a power converting device comprises a filter, a power factor corrector and a step-down converter. The filter is adapted to receive an alternating current (AC) input voltage, and filters out high frequency noise from the AC input voltage to generate a filtered voltage. The power factor corrector is coupled to the filter for receiving the filtered voltage therefrom. The power factor corrector boosts the filtered voltage to generate a boosted voltage, and includes a boost capacitor, a boost inductor, first and second diodes and first and second switches. The boost inductor has a first terminal coupled to the filter, and a second terminal. The first and second diodes are coupled in series across the boost capacitor. A common node between the first and second diodes is coupled to the second terminal of the boost inductor. The first and second switches are coupled in series across the boost capacitor. A voltage across the second switch serves as the boosted voltage. The step-down converter is coupled to the power factor corrector for receiving the boosted voltage therefrom. The step-down converter reduces the boosted voltage to generate a direct current (DC) output voltage.

According to another aspect of this invention, a power converting device comprises a filter, a power factor corrector and a step-down converter. The filter is adapted to receive an alternating current (AC) input voltage, and filters out high frequency noise from the AC input voltage to generate a filtered voltage. The power factor corrector is coupled to the filter for receiving the filtered voltage therefrom. The power factor corrector boosts the filtered voltage to generate a boosted voltage, and includes a boost capacitor, first and second boost inductors, first and second diodes and first and second switches. The first and second boost inductors and the first and second diodes are coupled in series across the boost capacitor, with the first and second boost inductors coupled to the boost capacitor. A common node between the first and second diodes is coupled to the filter. The first and second switches are coupled in series across the boost capacitor. A voltage across the second switch serves as the boosted voltage. The step-down converter is coupled to the power factor corrector for receiving the boosted voltage therefrom. The step-down converter reduces the boosted voltage to generate a direct current (DC) output voltage.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic circuit block diagram illustrating a conventional power converting device;

FIG. 2 is a schematic circuit block diagram illustrating the first preferred embodiment of a power converting device according to this invention;

FIG. 3 is a timing diagram illustrating operation of the first preferred embodiment;

FIGS. 4 to 14 are schematic equivalent circuit diagrams illustrating the first preferred embodiment when operating in first to eleventh modes, respectively;

FIG. 15 illustrates simulation waveforms of an alternating current (AC) input voltage and an AC input current received by the first preferred embodiment;

FIG. 16 illustrates simulation waveforms of a direct current (DC) output voltage and a DC output current generated by the first preferred embodiment;

FIG. 17 illustrates simulation waveforms of a voltage across a first switch of the first preferred embodiment and a current flowing through the same;

FIG. 18 illustrates simulation waveforms of a voltage across a second switch of the first preferred embodiment and a current flowing through the same;

FIG. 19 illustrates simulation waveforms of the voltage across the first switch of the first preferred embodiment and a current flowing through a third diode of the first preferred embodiment;

FIG. 20 illustrates simulation waveforms of the voltage across the second switch of the first preferred embodiment and a current flowing through a fourth diode of the first preferred embodiment;

FIG. 21 is a schematic circuit block diagram illustrating the second preferred embodiment of a power converting device according to this invention; and

FIG. 22 is a schematic circuit block diagram illustrating a modification of the second preferred embodiment.

### DETAILED DESCRIPTION OF THE PREFERRED EMBODIMENTS

Before describing this invention in detail, it should be noted herein that throughout this disclosure, when two elements are described as being “coupled in series,” “connected in series” or the like, it is merely intended to portray a serial connection between the two elements without necessarily implying that the currents flowing through the two elements are identical to each other and without limiting whether or not an additional element is coupled to a common node between the two elements. Essentially, “a series connection of elements,” “a series coupling of elements” or the like as used throughout this disclosure should be interpreted as being such when looking at those elements alone.

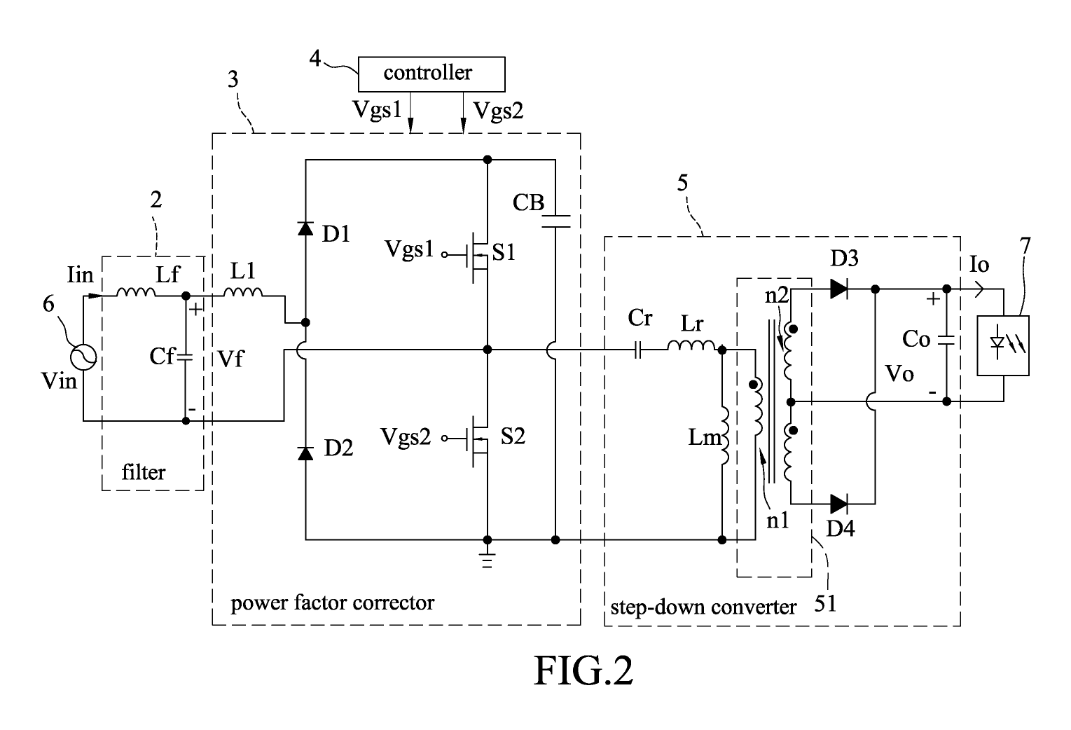

Referring to FIG. 2, the first preferred embodiment of a power converting device according to this invention is adapted to convert an alternating current (AC) input voltage (Vin) supplied by an AC power source 6 into a direct current (DC) output voltage (Vo). The DC output voltage (Vo) is used to drive a light emitting diode (LED) module 7 that serves as a load. The power converting device includes a filter 2, a power factor corrector 3, a controller 4 and a step-down converter 5.

The filter 2 is adapted to be coupled to the AC power source 6 for receiving the AC input voltage (Vin) therefrom, and filters out high frequency noise from the AC input voltage (Vin) to generate a filtered voltage (Vf). In this embodiment, the filter 2 includes a filtering inductor (Lf) and a filtering capacitor (Cf) that are adapted to be coupled in series across the AC power source 6, and a voltage across the filtering capacitor (Cf) serves as the filtered voltage (Vf).

The power factor corrector 3 is coupled to the filter 2 for receiving the filtered voltage (Vf) therefrom, and boosts the filtered voltage (Vf) to generate a boosted voltage. The power factor corrector 3 includes a boost capacitor (CB), a first boost inductor (L1), first and second diodes (D1, D2) and first and second switches (S1, S2). The first boost inductor (L1) has a first terminal coupled to a common node between the filtering inductor (Lf) and the filtering capacitor (Cf) of the filter 2, and a second terminal. The first and second diodes (D1, D2) are coupled in series across the boost capacitor (CB), with the first diode (D1) having an anode, and a cathode coupled to the boost capacitor (CB), and the second diode (D2) having an anode coupled to the boost capacitor (CB), and a cathode coupled to the anode of the first diode (D1). A common node between the first and second diodes (D1, D2) is coupled to the second terminal of the first boost inductor (L1). The first and second switches (S1, S2) are coupled in series across the boost capacitor (CB). A common node between the first and second switches (S1, S2) is coupled to a common node between the filtering capacitor (Cf) of the filter 2 and the AC power source 6. A voltage across the second switch (S2) serves as the boosted voltage. In this embodiment, each of the first and second switches (S1, S2) is a metal oxide semiconductor field effect transistor (MOSFET).

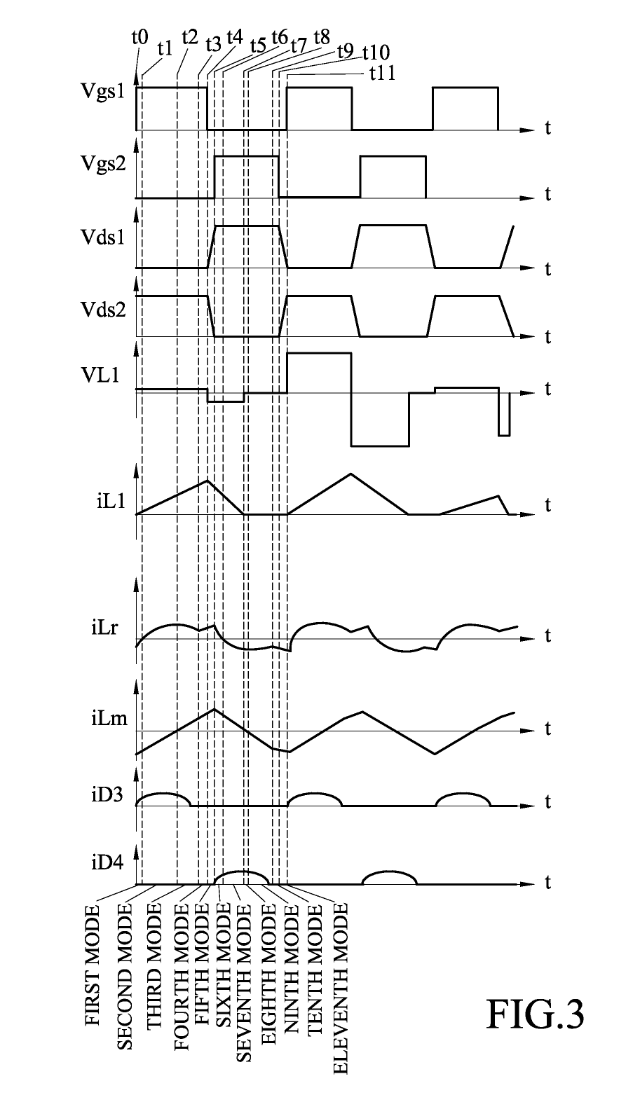

Each of the first and second switches (S1, S2) is operable between an ON state and an OFF state. The first and second switches (S1, S2) are operated alternately in the ON state based respectively on first and second control signals (Vgs1, Vgs2) shown in FIG. 3. When one of the first and second switches (S1, S2) is in the ON state, the other one of the first and second switches (S1, S2) is in the OFF state. Through operations of the first and second switches (S1, S2), the power factor corrector 3 allows a current flowing thereinto to have a phase that follows a phase of the AC input voltage (Vin). As a result, the AC input voltage (Vin) and an AC input current (Iin) from the AC power source 6 have the same phase, thereby attaining highpower factor and thus compliance with the IEC 61000-3-2 Class C standard. It is noted that interference to the AC input current (Iin) resulting from the operations of the first and second switches (S1, S2) is filtered out by the filter 2.

The controller 4 is coupled to the power factor corrector 3, and generates the first and second control signals (Vgs1, Vgs2).

The step-down converter 5 is coupled to the power factor corrector 3 for receiving the boosted voltage therefrom, and reduces the boosted voltage to generate the DC output voltage (Vo). In this embodiment, the step-down converter 5 has a resonant structure, and includes a resonant capacitor (Cr), a resonant inductor (Lr), an exciting inductor (Lm), a transformer 51, third and fourth diodes (D3, D4) and an output capacitor (Co). The resonant capacitor (Cr), the resonant inductor (Lr) and the exciting inductor (Lm) are coupled in series across the second switch (S2) of the power factor corrector 3. The transformer 51 includes a first winding (n1) that is coupled to the exciting inductor (Lm) in parallel, and a second winding (n2) that has first and second end terminals and an intermediate terminal. A winding ratio of the first winding (n1), a first portion of the second winding (n2) between the first end terminal and the intermediate terminal, and a second portion of the second winding (n2) between the intermediate terminal and the second end terminal is N1:N2:N3, where N1>N2 and N1>N3. The third diode (D3) has an anode coupled to the first end terminal of the second winding (n2) of the transformer 51, and a cathode. The fourth diode (D4) has an anode coupled to the second end terminal of the second winding (n2) of the transformer 51, and a cathode coupled to the cathode of the third diode (D3). The output capacitor (Co) is coupled between the cathode of the third diode (D3) and the intermediate terminal of the second winding (n2) of the transformer 51, and is adapted to be coupled to the LED module 7 in parallel. A voltage across the output capacitor (Co) serves as the DC output voltage (Vo).

Referring to FIGS. 3 to 14, the power converting device is operable among first to eleventh modes. FIG. 3 illustrates the first and second control signals (Vgs1, Vgs2), voltages (Vds1, Vds2, VL1) respectively across the first and second switches (S1, S2) and the first boost inductor (L1), and currents (iL1, iLr, iLm, iD3, iD4) flowing respectively through the first boost inductor (L1), the resonant inductor (Lr), the exciting inductor (Lm) and the third and fourth diodes (D3, D4). It is noted herein that the waves depicting the currents (iL1, iLr, iLm, iD3, iD4) in FIG. 3 convey information regarding both magnitudes and directions (with positive and negative amplitudes indicating opposite directions) of the respective currents.

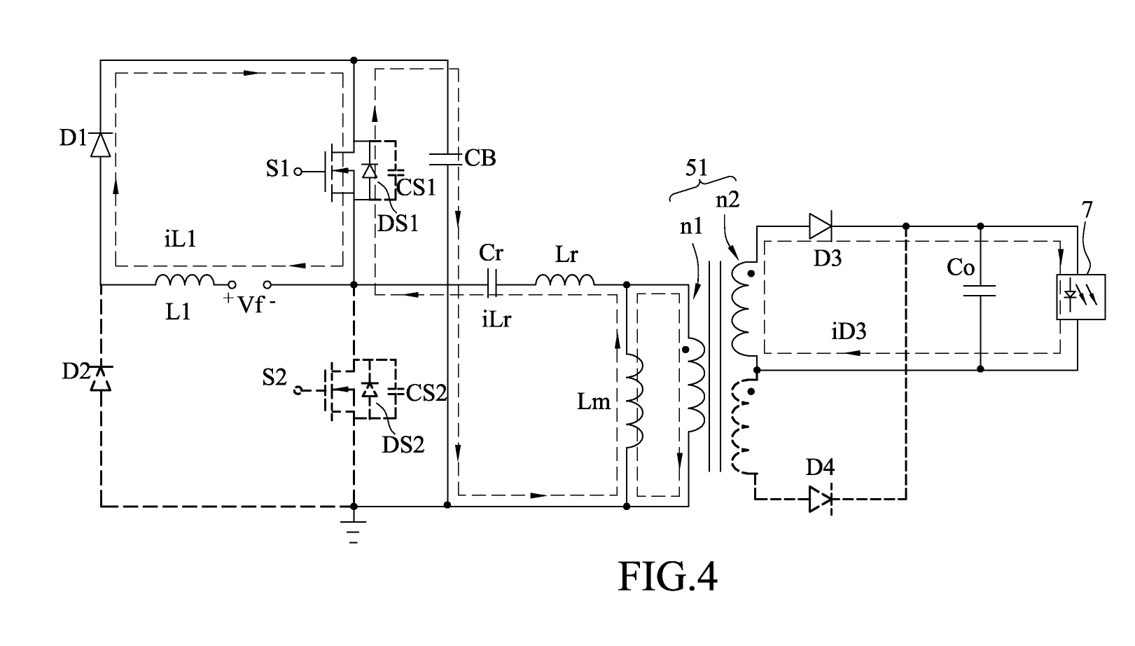

On the other hand, in the equivalent circuit diagrams of FIGS. 4 to 14, the directions of the currents are shown by corresponding arrows while the reference numerals “iL1”, “iLr”, “iLm”, “iD3”, “iD4” represent the magnitudes of the currents (iL1, iLr, iLm, iD3, iD4) only. In FIGS. 4 to 14, an intrinsic diode (DS1) and a parasitic capacitor (CS1) of the first switch (S1) and an intrinsic diode (DS2) and a parasitic capacitor (CS2) of the second switch (S2) are depicted. In addition, conducting components are depicted by solid lines, and non-conducting components are depicted by doted lines.

Referring to FIGS. 3 and 4, the power converting device operates in the first mode during a period from time t0 to time t1. In the first mode, the first switch (S1) enters the ON state with zero voltage switching (ZVS), and the second switch (S2) is in the OFF state. The first boost inductor (L1) is charged with the filtered voltage (Vf) through the first diode (D1) and the first switch (S1), and the current (iL1) flowing therethrough increases in magnitude. Energy stored in the exciting inductor (Lm) is released, a portion of which goes to the LED module 7 through the transformer 51 and the third diode (D3). The current (iLr) flowing through the resonant inductor (Lr) releases energy stored in the resonant capacitor (Cr) to the boost capacitor (CB) through the intrinsic diode (DS1) of the first switch (S1), and the waveform thereof rises from negative to zero.

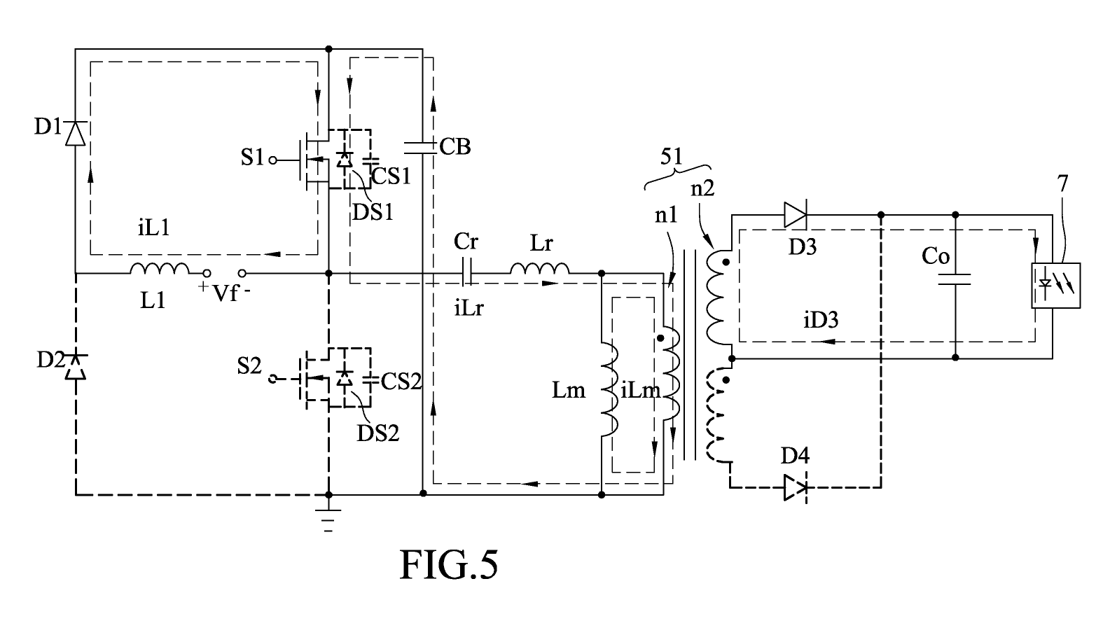

Referring to FIGS. 3 and 5, the power converting device operates in the second mode during a period from time t1 to time t2. In the second mode, the first switch (S1) remains in the ON state, and the second switch (S2) remains in the OFF state. The first boost inductor (L1) is still charged with the filtered voltage (Vf), and the current (iL1) flowing therethrough still increases in magnitude. Energy stored in the boost capacitor (CB) is released to the resonant capacitor (Cr) and the resonant inductor (Lr) through the first switch (S1), and further to the LED module 7 through the transformer 51 and the third diode (D3). Energy stored in the exciting inductor (Lm) is also released to the LED module 7 through the transformer 51 and the third diode (D3), and the current (iLm) flowing through the same rises from negative to zero.

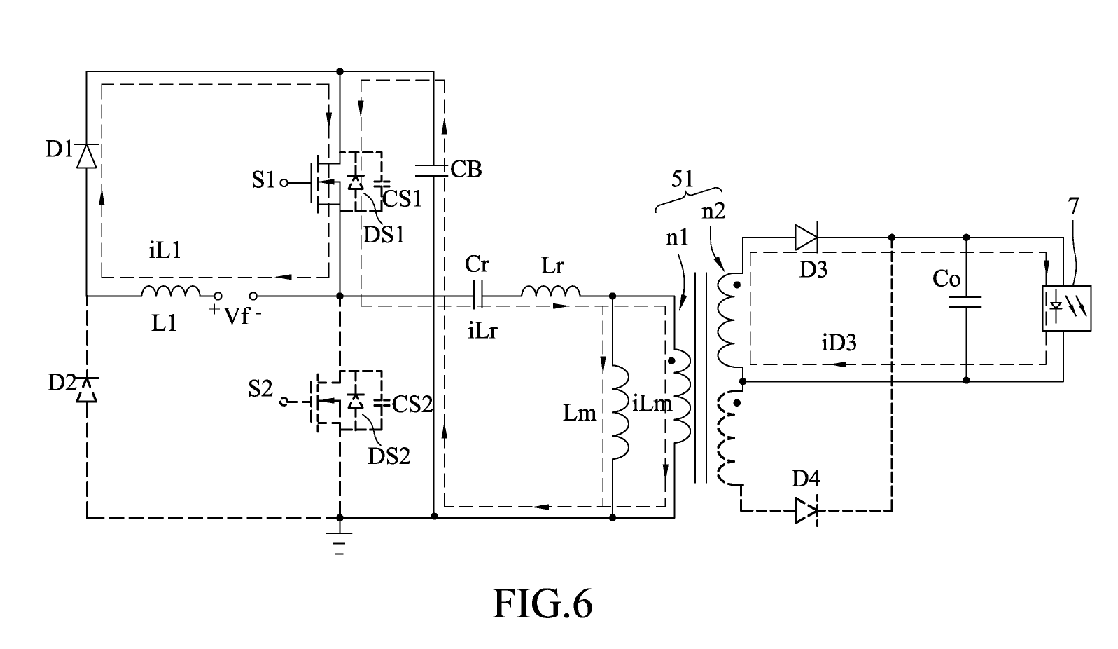

Referring to FIGS. 3 and 6, the power converting device operates in the third mode during a period from time t2 to time t3. In the third mode, the first switch (S1) remains in the ON state, and the second switch (S2) remains in the OFF state. The first boost inductor (L1) is still charged with the filtered voltage (Vf). Energy stored in the boost capacitor (CB) and the resonant inductor (Lr) is released to the exciting inductor (Lm), and further to the LED module 7 through the transformer 51 and the third diode (D3). The current (iLr) flowing through the resonant inductor (Lr) decreases in magnitude and the current (iLm) flowing through the exciting inductor (Lm) increases in magnitude until the current (iLr) is equal to the current (iLm).

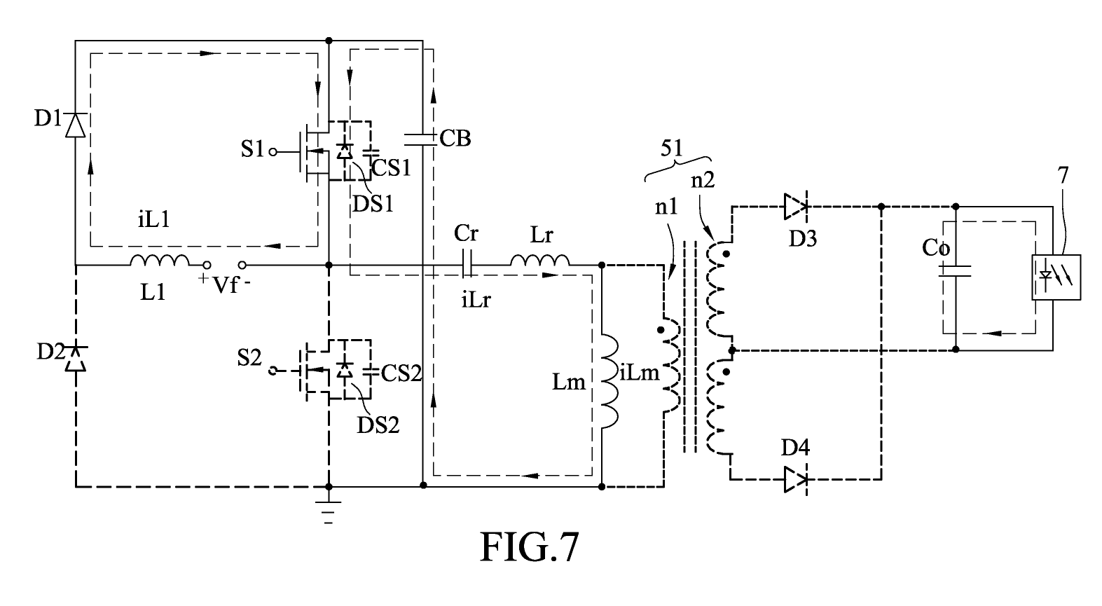

Referring to FIGS. 3 and 7, the power converting device operates in the fourth mode during a period from time t3 to time t4. In the fourth mode, the first switch (S1) remains in the ON state, and the second switch (S2) remains in the OFF state. The first boost inductor (L1) is still charged with the filtered voltage (Vf), and the current (iL1) flowing therethrough increases to its maximum value. Since the current (iLr) flowing through the resonant inductor (Lr) is equal to the current (iLm) flowing through the exciting inductor (Lm), the current (iD3) flowing the third diode (D3) is zero, and energy stored in the output capacitor (Co) is released to the LED module 7.

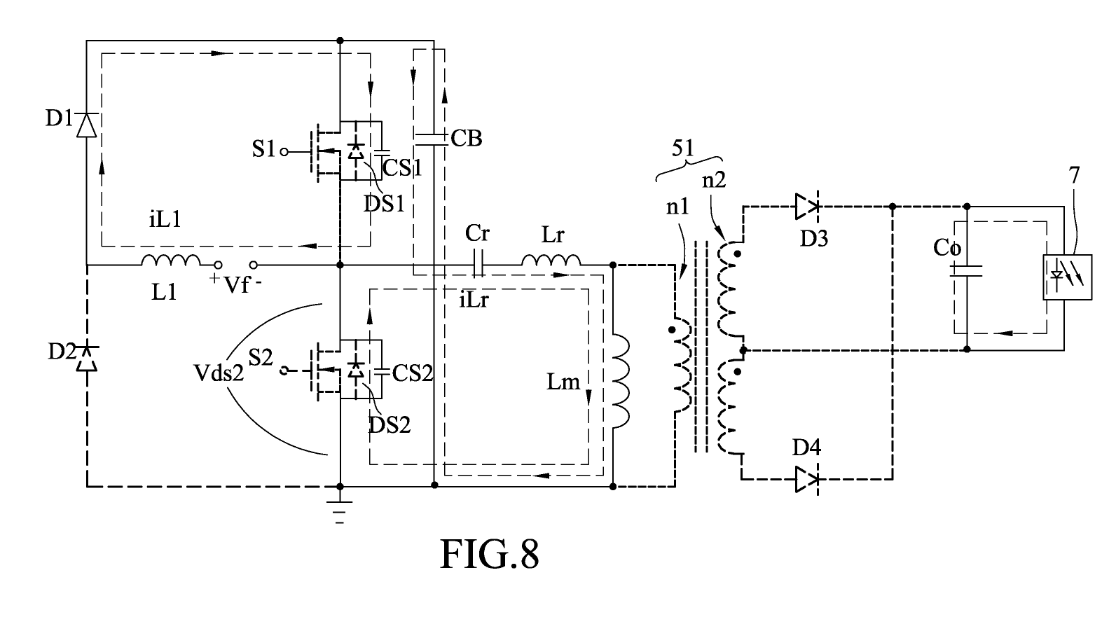

Referring to FIGS. 3 and 8, the power converting device operates in the fifth mode during a period from time t4 to time t5. In the fifth mode, the first switch (S1) enters the OFF state, and the second switch (S2) remains in the OFF state. Energy stored in the first boost inductor (L1) is released to the parasitic capacitor (CS1) of the first switch (S1), and the current (iL1) flowing through the same decreases in magnitude. Energy stored in the boost capacitor (CB) is released to the parasitic capacitor (CS1) of the first switch (S1) and the resonant capacitor (Cr). Energy stored in the parasitic capacitor (CS2) of the second switch (S2) is released, and the voltage (Vds2) across the second switch (S2) drops from positive to zero.

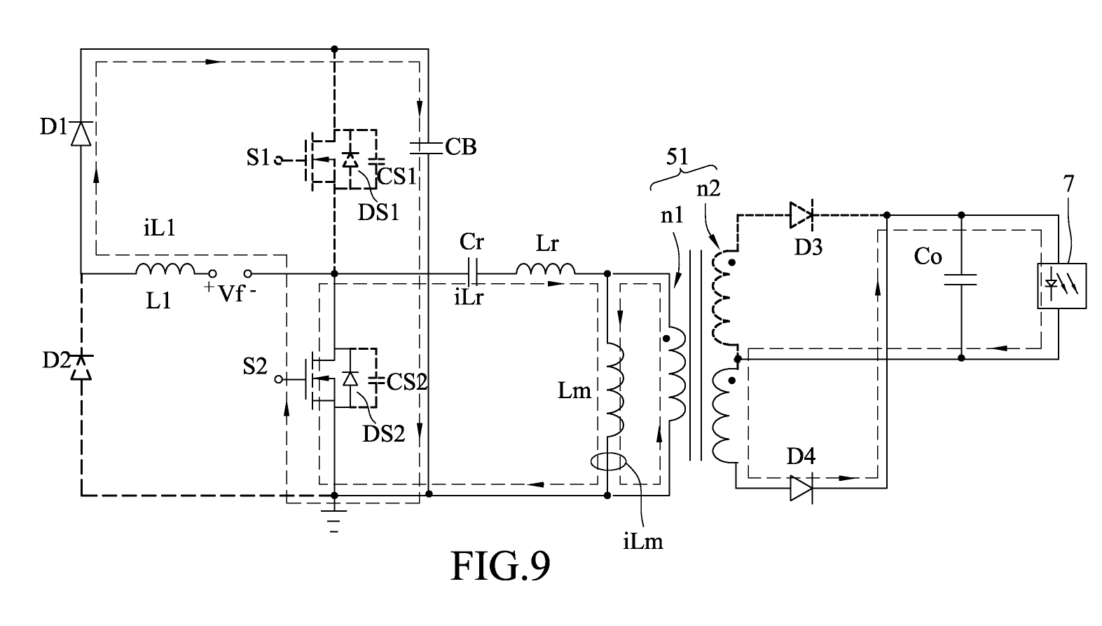

Referring to FIGS. 3 and 9, the power converting device operates in the sixth mode during a period from time t5 to time t6. In the sixth mode, the first switch (S1) remains in the OFF state, and the second switch (S2) enters the ON state with ZVS. Energy stored in the first boost inductor (L1) is released to the boost capacitor (CB) through the first diode (D1) and the second switch (S2), and the current (iL1) flowing through the same decreases in magnitude. Energy stored in the exciting inductor (Lm) is released, a portion of which goes to the LED module 7 through the transformer 51 and the fourth diode (D4), and the current (iLm) flowing through the same decreases in magnitude. Energy stored in the resonant inductor (Lr) is released to the resonant capacitor (Cr) through the intrinsic diode (DS2) of the second switch (S2), and the current (iLr) flowing through the same drops from positive to zero.

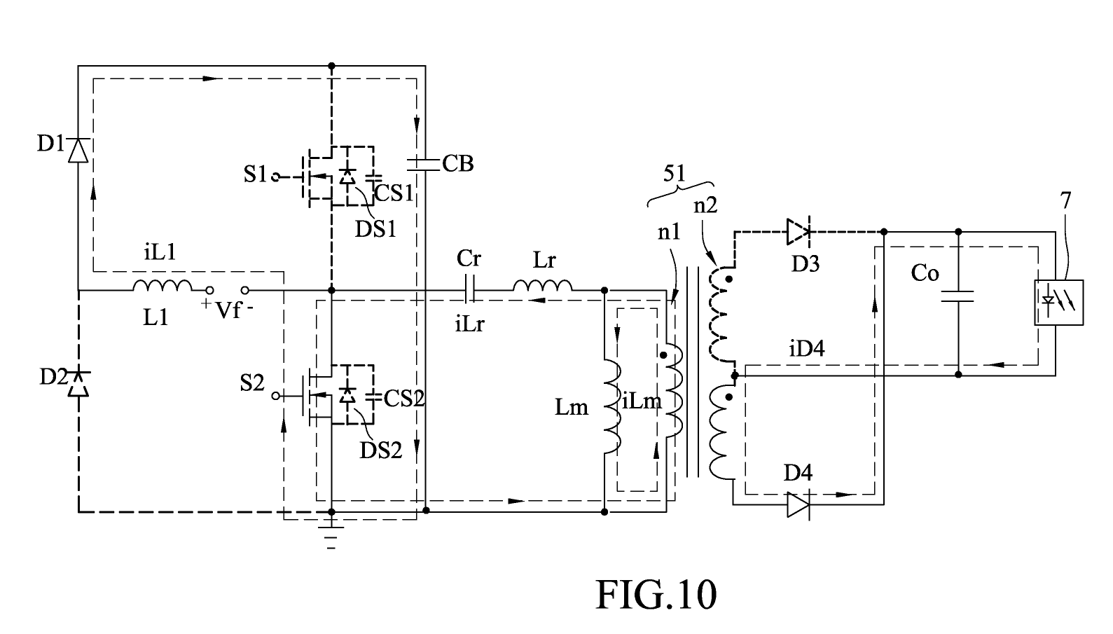

Referring to FIGS. 3 and 10, the power converting device operates in the seventh mode during a period from time t6 to time t7. In the seventh mode, the first switch (S1) remains in the OFF state, and the second switch (S2) remains in the ON state. Energy stored in the first boost inductor (L1) is still released to the boost capacitor (CB), and the current (iL1) flowing through the same drops from positive to zero. Energy stored in the resonant capacitor (Cr) is released to the resonant inductor (Lr), and further to the LED module 7 through the transformer 51 and the fourth diode (D4). Energy stored in the exciting inductor (Lm) is also released to the LED module 7 through the transformer 51 and the fourth diode (D4), and the current (iLm) flowing through the same keeps on decreasing in magnitude.

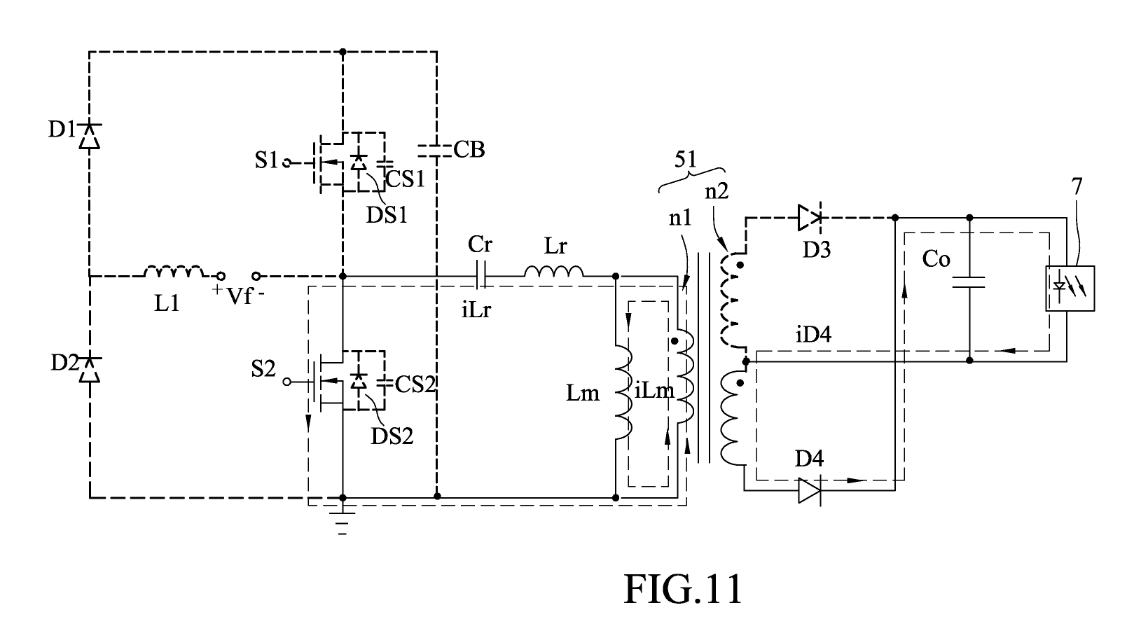

Referring to FIGS. 3 and 11, the power converting device operates in the eighth mode during a period from time t7 to time t8. In the eighth mode, the first switch (S1) remains in the OFF state, and the second switch (S2) remains in the ON state. Energy stored in the resonant capacitor (Cr) and the exciting inductor (Lm) is still released, and the current (iLm) flowing through the exciting inductor (Lm) drops from positive to zero.

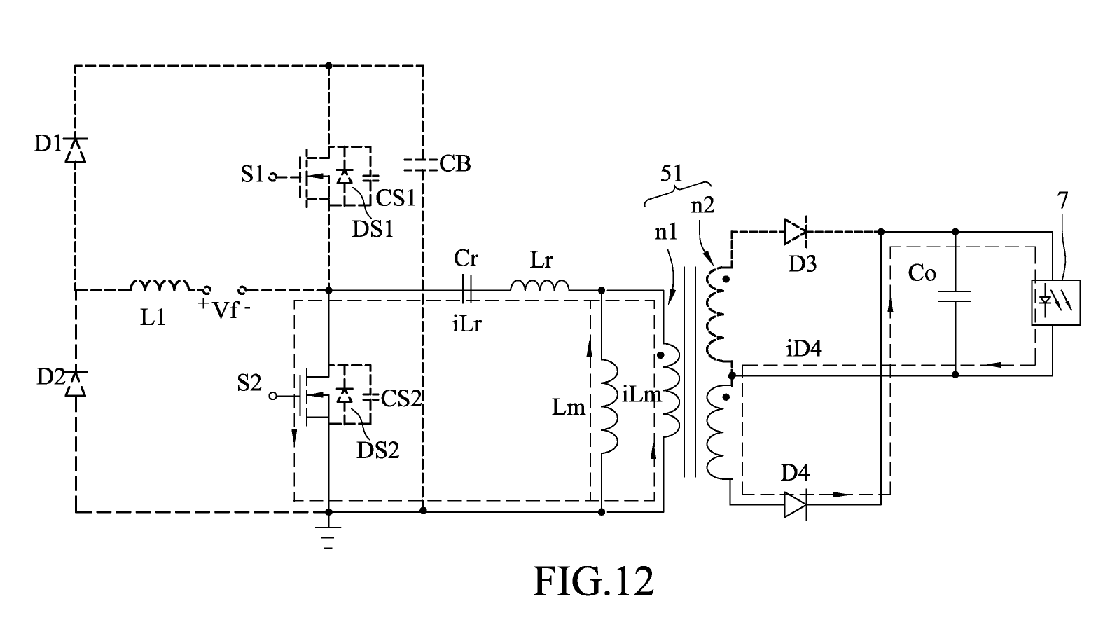

Referring to FIGS. 3 and 12, the power converting device operates in the ninth mode during a period from time t8 to time t9. In the ninth mode, the first switch (S1) remains in the OFF state, and the second switch (S2) remains in the ON state. Energy stored in the resonant capacitor (Cr) is released to the exciting inductor (Lm), the resonant inductor (Lr) and the LED module 7. The current (iLr) flowing through the resonant inductor (Lr) has a rising waveform below zero (i.e., decreases in magnitude) and the current (iLm) flowing through the exciting inductor (Lm) drops below zero (i.e., increases in magnitude) until the current (iLr) is equal to the current (iLm).

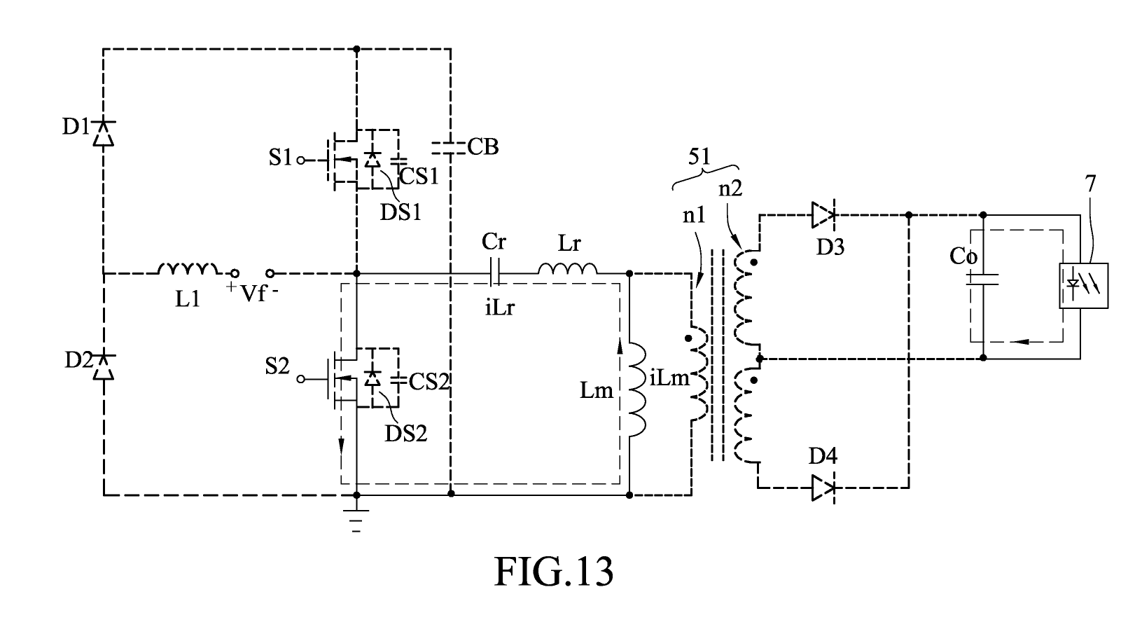

Referring to FIGS. 3 and 13, the power converting device operates in the tenth mode during a period from time t9 to time t10. In the tenth mode, the first switch (S1) remains in the OFF state, and the second switch (S2) remains in the ON state. Since the current (iLr) flowing through the resonant inductor (Lr) is equal to the current (iLm) flowing through the exciting inductor (Lm), the current (iD4) flowing through the fourth diode (D4) is zero, and the energy stored in the output capacitor (Co) is released to the LED module 7.

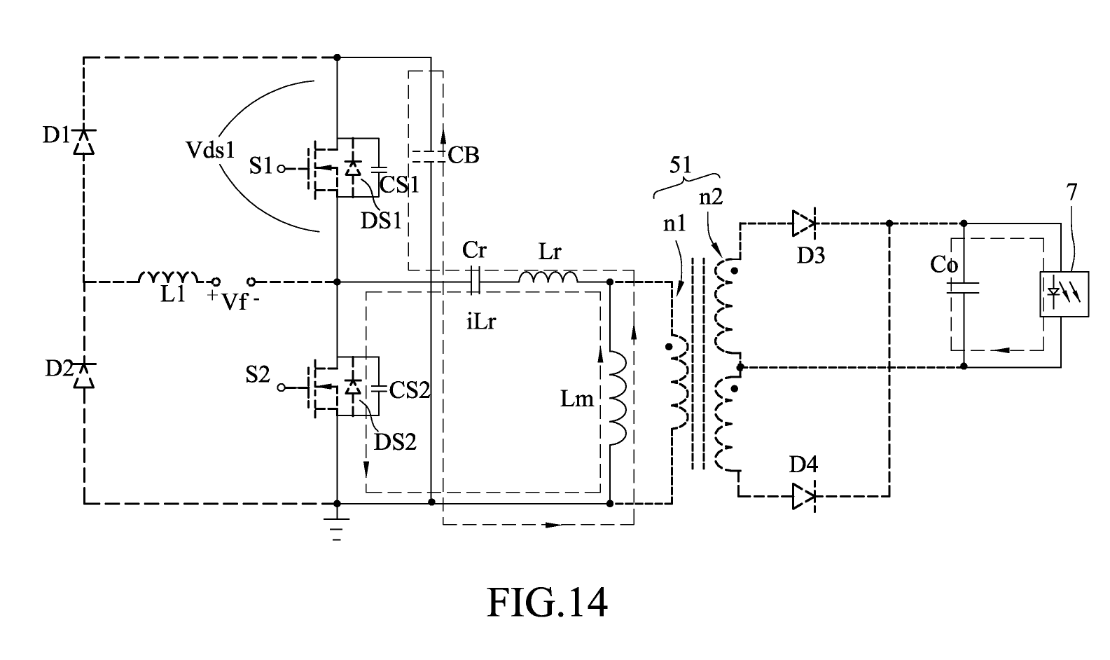

Referring to FIGS. 3 and 14, the power converting device operates in the eleventh mode during a period from time t10 to time t11. In the eleventh mode, the first switch (S1) remains in the OFF state, and the second switch (S2) enters the OFF state. Energy stored in the resonant capacitor (Cr) is released to the parasitic capacitor (CS2) of the second switch (S2). Energy stored in the parasitic capacitor (CS1) of the first switch (S1) is released to the resonant inductor (Lr), the resonant capacitor (Cr) and the boost capacitor (CB), and the voltage (Vds1) across the first switch (S1) drops from positive to zero.

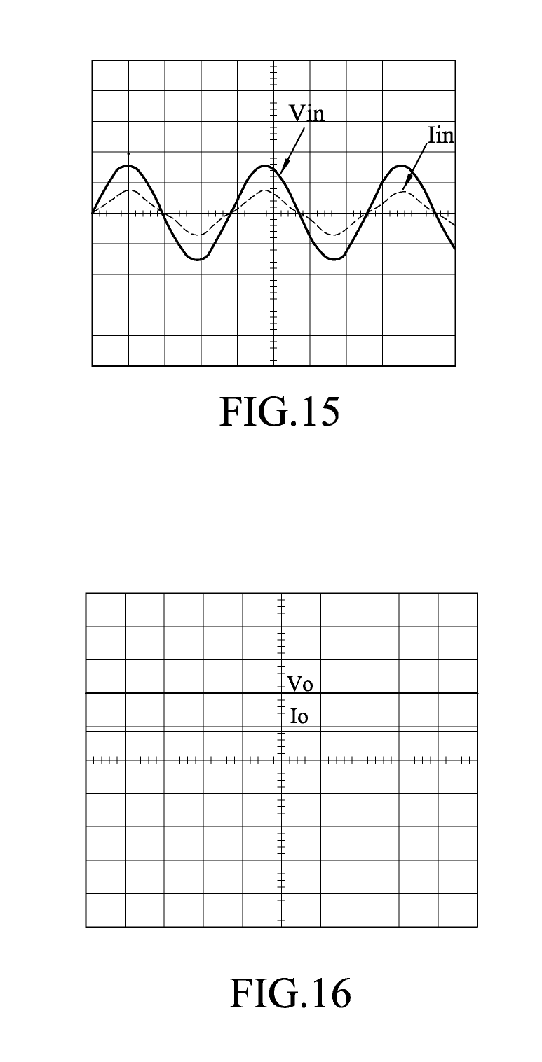

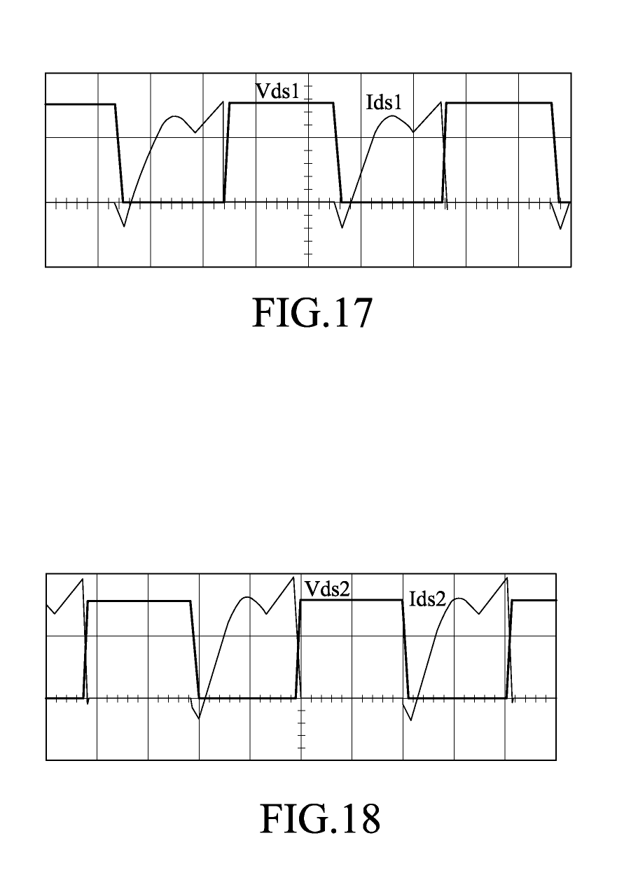

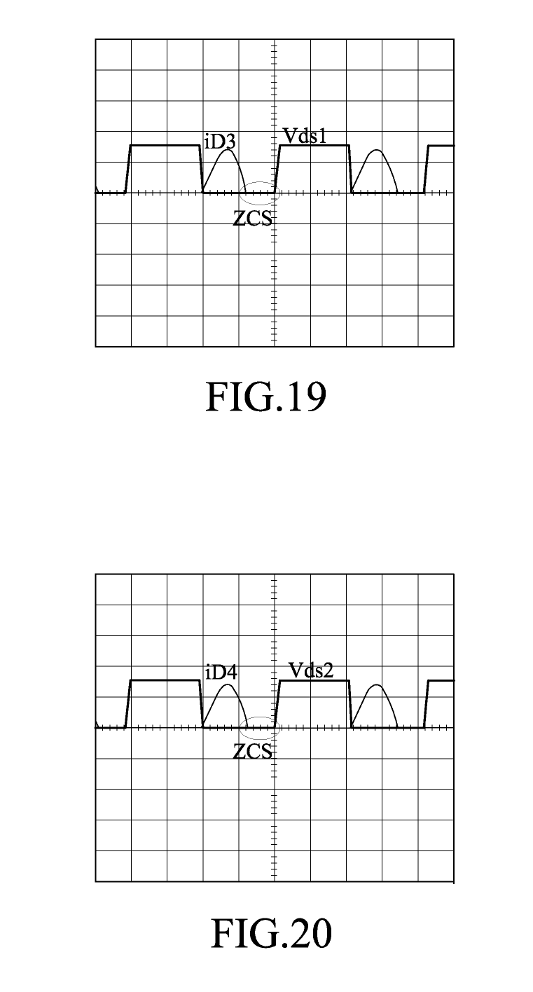

Referring to FIGS. 2 and 15-20, simulation results of the power converting device are shown. FIG. 15 illustrates the AC input voltage (Vin) and the AC input current (Iin) from the AC power source 6. It is known from FIG. 15 that the AC input voltage (Vin) and the AC input current (Iin) have the same phase. FIG. 16 illustrates the DC output voltage (Vo) and a DC output current (Io) generated by the step-down converter 5. FIG. 17 illustrates the voltage (Vds1) across the first switch (S1) and a current (Ids1) flowing through the same. FIG. 18 illustrates the voltage (Vds2) across the second switch (S2) and a current (Ids2) flowing through the same. It is known from FIGS. 17 and 18 that each of the first and second switches (S1, S2) operates with ZVS. FIG. 19 illustrates the voltage (Vds1) across the first switch (S1) and the current (iD3) flowing through the third diode (D3). FIG. 20 illustrates the voltage (Vds2) across the second switch (S2) and the current (iD4) flowing through the fourth diode (D4). It is known from FIGS. 19 and 20 that each of the first and second switches (S1, S2) operates with zero current switching (ZCS).

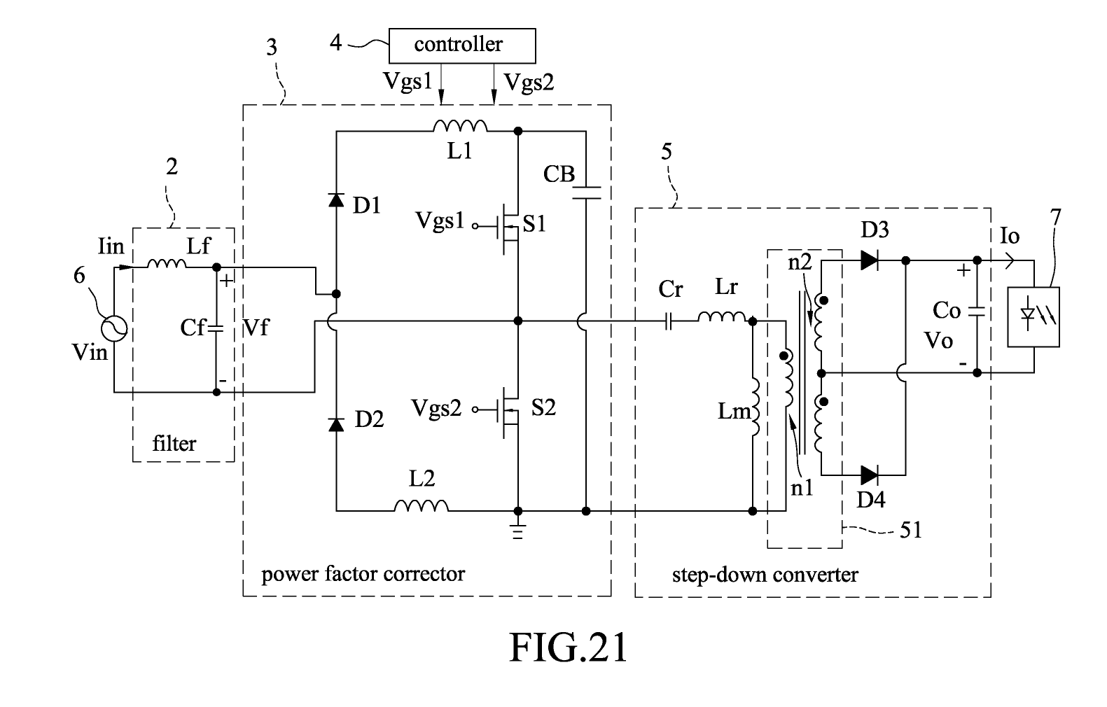

FIG. 21 illustrates the second preferred embodiment of a power converting device according to this invention, which is a modification of the first preferred embodiment. Unlike the first preferred embodiment, the power factor corrector 3 of the second preferred embodiment further includes a second boost inductor (L2). The first and second boost inductors (L1, L2) and the first and second diodes (D1, D2) are coupled in series across the boost capacitor (CB), with the first boost inductor (L1) coupled between the boost capacitor (CB) and the cathode of the first diode (D1), the second boost inductor (L2) coupled between the boost capacitor (CB) and the anode of the second diode (D2), and the cathode of the second diode (D2) coupled to the anode of the first diode (D1). The common node between the first and second diodes (D1, D2) is coupled to the common node between the filtering inductor (Lf) and the filtering capacitor (Cf) of the filter 2.

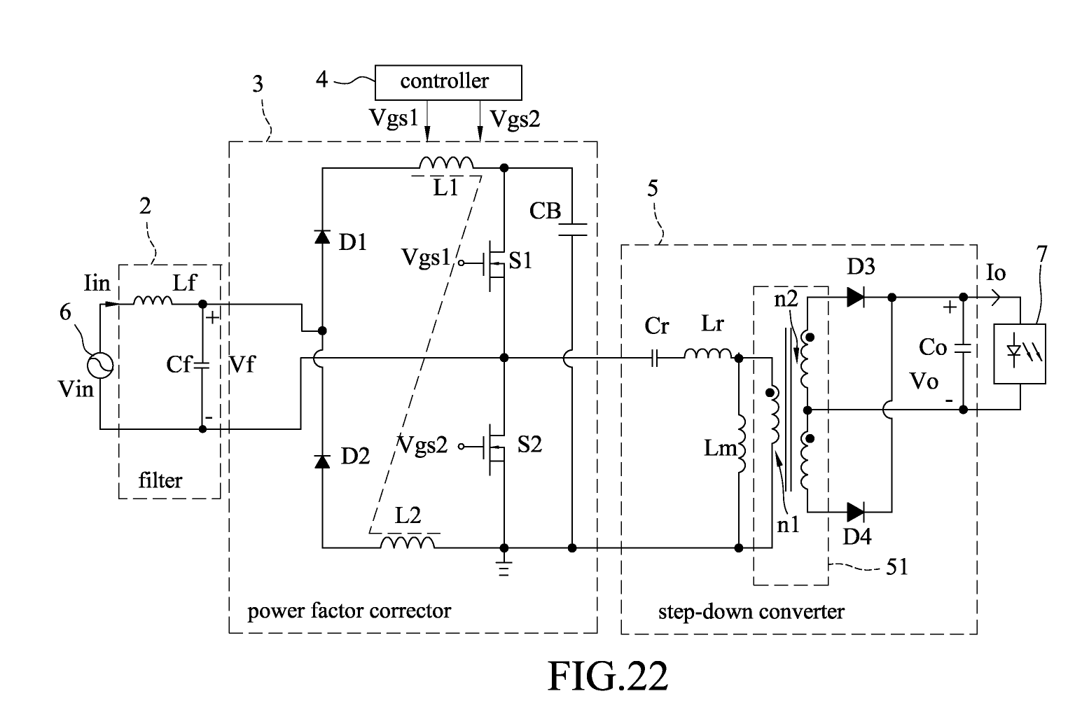

FIG. 22 illustrates a modification of the second preferred embodiment, wherein the first and second boost inductors (L1, L2) are integrated into a unitary coupling inductor.

In view of the above, compared to the conventional power converting device, the power converting device of each of the first and second preferred embodiments has the following advantages:

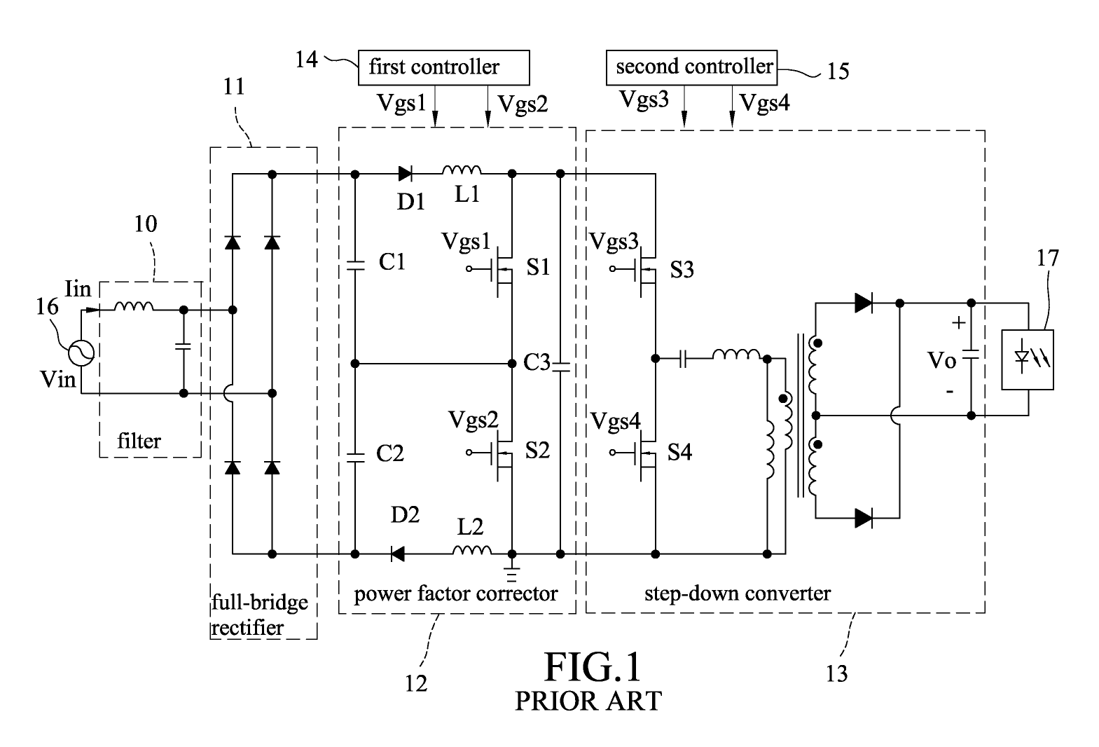

1. Since the power factor corrector 3 includes a relatively small number of components, and the full-bridge rectifier 11 (see FIG. 1) is not required, the power converting device has a relatively low cost.

2. Two switches (S1, S2) are required in the power converting device, as opposed to four (see FIG. 1).

3. Since the mere inclusion of the two switches (S1, S2) only requires two control signals (Vgs1, Vgs2) for control thereof, control logic (including the controller 4) of the power converting device is relatively simple.

4. Since the DC output voltage (Vo) is generated through a three-stage process (including the filtering by the filter 2, the boost by the power factor corrector 3 and the reduction by the step-down converter 5), since only two switches (S1, S2) are required, and since the control logic is relatively simple, the power converting device has relatively high power conversion efficiency.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A power converting device comprising:
a filter adapted to receive an alternating current (AC) input voltage, and filtering out high frequency noise from the AC input voltage to generate a filtered voltage;
a power factor corrector coupled to said filter for receiving the filtered voltage therefrom, said power factor corrector boosting the filtered voltage to generate a boosted voltage, and including
a boost capacitor,
a boost inductor that has a first terminal coupled to said filter, and a second terminal,
first and second diodes that are coupled in series across said boost capacitor, a common node between said first and second diodes being coupled to said second terminal of said boost inductor, and
first and second switches that are coupled in series across said boost capacitor, a voltage across said second switch serving as the boosted voltage; and
a step-down converter coupled to said power factor corrector for receiving the boosted voltage therefrom, said step-down converter reducing the boosted voltage to generate a direct current (DC) output voltage.

2. The power converting device of claim 1, wherein each of said first and second switches of said power factor corrector is operable between an ON state and an OFF state, said first and second switches being operated alternately in the ON state based respectively on first and second control signals, when one of said first and second switches is in the ON state, the other one of said first and second switches being in the OFF state.

3. The power converting device of claim 2, further comprising a controller that is coupled to saidpower factor corrector and that generates the first and second control signals.

4. The power converting device of claim 1, wherein said filter includes a filtering inductor and a filtering capacitor that are adapted to be coupled in series across an AC power source supplying the AC input voltage, a voltage across said filtering capacitor serving as the filtered voltage.

5. The power converting device of claim 4, wherein:
said first terminal of said boost inductor is coupled to a common node between said filtering inductor and said filtering capacitor of said filter;
said first diode has an anode, and a cathode coupled to said boost capacitor;
said second diode has an anode coupled to said boost capacitor, and a cathode coupled to said anode of said first diode; and
a common node between said first and second switches is coupled to a common node between said filtering capacitor of said filter and the AC power source.

6. The power converting device of claim 1, wherein said step-down converter includes:
a resonant capacitor, a resonant inductor and an exciting inductor coupled in series across said second switch of said power factor corrector;
a transformer including a first winding that is coupled to said exciting inductor in parallel, and a second winding that has first and second end terminals and an intermediate terminal;
a third diode having an anode that is coupled to said first end terminal of said second winding of said transformer, and a cathode;
a fourth diode having an anode that is coupled to said second end terminal of said second winding of said transformer, and a cathode that is coupled to said cathode of said third diode; and
an output capacitor coupled between said cathode of said third diode and said intermediate terminal of said second winding of said transformer, a voltage across said output capacitor serving as the DC output voltage.

7. A power converting device comprising:
a filter adapted to receive an alternating current (AC) input voltage, and filtering out high frequency noise from the AC input voltage to generate a filtered voltage;
a power factor corrector coupled to said filter for receiving the filtered voltage therefrom, said power factor corrector boosting the filtered voltage to generate a boosted voltage, and including
a boost capacitor,
first and second boost inductors and first and second diodes that are coupled in series across said boost capacitor with said first and second boost inductors coupled to said boost capacitor, a common node between said first and second diodes being coupled to said filter, and
first and second switches that are coupled in series across said boost capacitor, a voltage across said second switch serving as the boosted voltage; and
a step-down converter coupled to said power factor corrector for receiving the boosted voltage therefrom, said step-down converter reducing the boosted voltage to generate a direct current (DC) output voltage.

8. The power converting device of claim 7, wherein each of said first and second switches of said power factor corrector is operable between an ON state and an OFF state, said first and second switches being operated alternately in the ON state based respectively on first and second control signals, when one of said first and second switches is in the ON state, the other one of said first and second switches being in the OFF state.

9. The power converting device of claim 8, further comprising a controller that is coupled to said power factor corrector and that generates the first and second control signals.

10. The power converting device of claim 7, wherein said filter includes a filtering inductor and a filtering capacitor that are adapted to be coupled in series across an AC power source supplying the AC input voltage, a voltage across said filtering capacitor serving as the filtered voltage.

11. The power converting device of claim 10, wherein:
said first diode has an anode coupled to a common node between said filtering inductor and said filtering capacitor of said filter, and a cathode coupled to said first boost inductor;
said second diode has an anode coupled to said second boost inductor, and a cathode coupled to said anode of said first diode; and
a common node between said first and second switches is coupled to a common node between said filtering capacitor of said filter and the AC power source.

12. The power converting device of claim 7, wherein said step-down converter includes:
a resonant capacitor, a resonant inductor and an exciting inductor coupled in series across said second switch of said power factor corrector;
a transformer including a first winding that is coupled to said exciting inductor in parallel, and a second winding that has first and second end terminals and an intermediate terminal;
a third diode having an anode that is coupled to said first end terminal of said second winding of said transformer, and a cathode;
a fourth diode having an anode that is coupled to said second end terminal of said second winding of said transformer, and a cathode that is coupled to said cathode of said third diode; and
an output capacitor coupled between said cathode of said third diode and said intermediate terminal of said second winding of said transformer, a voltage across said output capacitor serving as the DC output voltage.

13. The power converting device of claim 7, wherein said first and second boost inductors of said power factor corrector are integrated into a unitary coupling inductor.
